(19) United States
(12) Patent Application Publication
(10) Pub. No.: US 2015/0365178 A1
(43) Pub. Date: Dec. 17, 2015

(54) SYSTEM, METHOD, AND APPARATUS FOR SIGNALING INTEFERING CELL INFORMATION

(71) Applicant: Broadcom Corporation, Irvine, CA (US)

(72) Inventors: Helka-Liina MAATTANEN, Helsinki (FI); Kari Tapio MAJONEN, Haukipudas (FI); Markku HEIKKILA, Oulu (FI); Mads HINTZ-MADSEN, Oulu (FI); Sami-Jukka HAKOLA, Kempele (FI); Karl Marko Juhani LAMPINEN, Oulu (FI)

(73) Assignee: Broadcom Corporation, Irvine, CA (US)

(21) Appl. No.: 14/737,465

(22) Filed: Jun. 11, 2015

Related U.S. Application Data
(60) Provisional application No. 62/011,502, filed on Jun. 12, 2014.

(51) Int. Cl. H04B 15/00; H04B 17/345

(52) U.S. Cl. CPC H04B 15/00; H04B 17/345

(57) ABSTRACT

An apparatus includes circuitry configured to determine that one or more neighbor transmission cells have interfering downlink data channels to be transmitted by one or more antenna groups. Virtual configuration parameters are determined for the interfering downlink data channels. The circuitry is also configured to signal, to at least one user equipment (UE) served by a serving cell that is one of the one or more neighbor transmission cells having interfering downlink data channels, the virtual configuration parameters for the interfering downlink data channels.

### CROSS-REFERENCE TO RELATED PATENT APPLICATIONS

The present application claims the benefit of the earlier filing date of U.S. provisional application 62/011,502 having common inventorship with the present application and filed in the U.S. Patent and Trademark Office on Jun. 12, 2014, the entire contents of which being incorporated herein by reference.

### BACKGROUND

1. Technical Field

The exemplary and non-limiting embodiments of the present disclosure relate generally to wireless communication systems, methods, devices and computer programs, and more specifically relate to the signaling of information to at least one user equipment (UE) to assist with mitigating and/or avoiding interference from neighbor cell downlink transmissions in cells that are neighbor to the UE's serving cell, particularly where the neighbor cell is a shared cell having multiple non co-located transmission points.

2. Description of the Related Art

In the Third Generation Partnership Project (3GPP) for evolved UMTS Terrestrial Radio Access Network (E-UTRAN), also referred to as LTE and including LTE-Advanced, Network Assistance Interference Cancellation and Suppression (NAICS) specifies signaling and performance metrics and requirements for a receiver to mitigate inter-cell interference from neighbor cell physical downlink shared channels (PDSCHs). For example, delineation of NAICS techniques are described in document RP-140519 entitled, “Network Assistance Interference Cancellation and Suppression for LTE,” by MediaTek Inc., 3GPP TSG RAN Meeting #63; Fukuoka, Japan; 3-6 Mar. 2014 and document “Draft Report of 3GPP TSG RAN meeting #63”, by ETSI MCC, Fukuoka, Japan: 3-6 Mar. 2014. In addition, 3GPP TR 36.866, “Study on Network-Assisted Interference Cancellation and Suppression (NAIC) for LTE”, 2014, provides additional background related to receiver algorithms.

In order for the UE to efficiently mitigate the PDSCH interference originating from other neighbor cells, several parameters are known or estimated. Some parameters are signaled by higher layers, such as by radio resource control (RRC) signaling, or the range of values for the parameters can be restricted. A status of 3GPP agreements can be found at

“Draft Report of 3GPP TSG RAN WG1 #77 v0.1.0,” 3GPP TSG RAN WG1 Meeting #77; Seoul, Korea; 19-23 May 2014.

The RRC signaling for mitigating common (cell-specific) reference signal (CRS) transmissions from neighboring cells has already been specified in the LTE system. One proposal is to reuse the CRS assistance signaling for NAICS purposes as described by the document R1-142162, entitled “Discussion on higher-layer signaling for NAICS,” by LG Electronics; 3GPP TSG RAN WG1 Meeting #77; Seoul, Korea; 19-23 May 2014.

Being able to avoid and/or mitigate the effects of interference between downlink transmissions such as PDSCHs is based on the UE's ability to receive information about the actual transmission points that are sending the potentially interfering downlink transmissions.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary schematic diagram illustrating a radio environment, according to certain embodiments;

FIGS. 2A-2E are exemplary related art tables of information elements, according to certain embodiments;

FIG. 3A is an exemplary illustration of a format for providing NAICS assistance information for a same cell to a UE, according to certain embodiments;

FIG. 3B is an exemplary illustration of a format for providing NAICS assistance information for a shared cell to a UE, according to certain embodiments;

FIG. 4 is an exemplary illustration of format for providing NAICS assistance information for a shared and/or same cell to a UE, according to certain embodiments;

FIG. 5 is an exemplary schematic diagram illustrating a network's signaling of NAICS assistance information to a UE, according to certain embodiments;

FIG. 6 is an exemplary flowchart of a UE signaling process, according to certain embodiments;

FIG. 7 is a non-limiting example of a processor, according to certain embodiments; and

FIG. 8 is a high level schematic block diagram of the radio environment, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “about,” and similar terms generally refer to ranges that include the identified value within a margin of 20%, 10%, or preferably 5%, and any values therebetween.

In an exemplary embodiment, an apparatus includes circuitry configured to determine that one or more neighbor transmission cells have interfering downlink data channels to be transmitted by one or more antenna groups. Virtual configuration parameters are determined for the interfering downlink data channels. The circuitry is also configured to signal, to at least one user equipment (UE) served by a serving cell that is one of the one or more neighbor transmission cells having interfering downlink data channels, the virtual configuration parameters for the interfering downlink data channels.

In another exemplary embodiment, a method includes determining that one or more neighbor transmission cells have interfering downlink data channels to be transmitted by one or more antenna groups; determining virtual configuration parameters for the interfering downlink data channels; and signaling, to at least one UE served by a serving cell that is one of the one or more neighbor transmission cells having interfering downlink data channels, the virtual configuration parameters for the interfering downlink data channels.

In another exemplary embodiment, a serving cell includes: circuitry configured to identify transmission points associated with one or more interfering antenna groups, determine virtual configuration parameters for the transmission points based on physical layer and higher layer attributes of the transmission points, and signal, to at least one user equipment (UE) served by the serving cell, the virtual configuration parameters associated with the transmission points.

Aspects of the present disclosure are directed to a UE operating in an E-UTRAN (LTE) network, which is only one example of a suitable radio environment in which these teachings can be deployed, used here only to provide a practical context for describing the inventive concepts detailed herein. These teachings may be utilized when the UE is operating in networks deploying other radio access technologies, such as for example EUTRAN, wideband code division multiple access (WCDMA), high-speed downlink packet access (HSDPA), and the like.

In LTE systems, two types of neighbor cells can be used. First, a same cell identity (ID) cell refers to a serving cell where all transmit antennas are geographically co-located. The same cell ID definition can also be understood as a conventional multiple-input/multiple-output (MIMO) cell where a number of antennas transmit the common reference signal (CRS) using the same cell ID information. In a shared cell ID cell, the transmit antennas are not co-located and thus at different physical locations, which can also be referred to as being geographically distinct. In the shared cell ID case, antennas that are co-located form a transmission point (TP) such that one or more TPs make up a shared cell ID. According to certain embodiments, in LTE, there can be 504 unique physical-layer cell identities (PCIDs) defined and each cell is assigned one cell identity number, whereas all TPs within a cell coverage area share the same physical cell ID (PCID). The PCID is used to scramble the CRS transmitted from the cell, and all TPs within a cell send the same CRS. Also, in shared cell ID implementations, the channel state information reference signal (CSI-RS) may be configured such that each TP has its own corresponding CSI-RS configuration. A TP may have an associated virtual cell ID for PDSCH transmissions that can be based on the PCID and CSI-RS configuration.

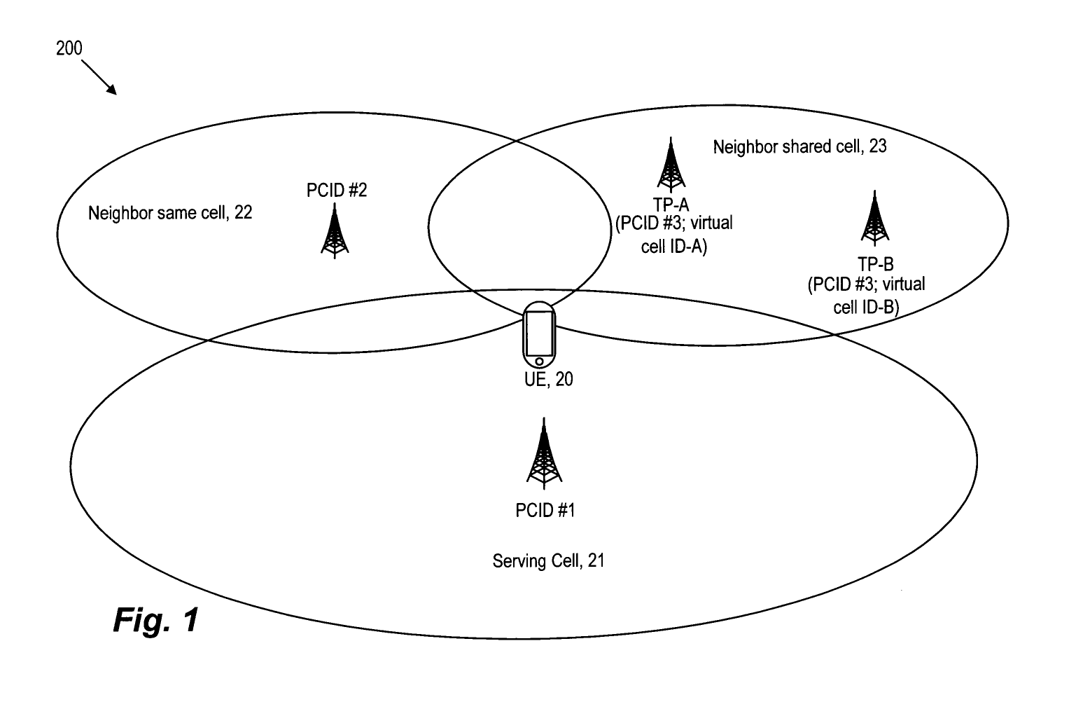

FIG. 1 is an exemplary schematic diagram illustrating a radio environment 200, according to certain embodiments. The radio environment 200 can be a network where a UE 20 wirelessly communicates with a serving cell 21 (which may be a same cell or a shared cell), which can be an e-NodeB (eNB), using PCID#1 and is adjacent to a neighbor same cell 22 and a neighbor shared cell 23, in close enough proximity such that downlink transmissions, such as data transmissions on respective PDSCHs, may have a potential for interference at the UE 20. The neighbor same cell 22 uses PCID#2 to scramble the CRS. Because the neighbor cell 22 is a same cell, all of the associated MIMO transmit antennas for sending this scrambled CRS are co-located at a singular antenna tower (representing an eNB), according to one implementation. The antenna tower can also be interchangeably referred to as a base station (BS) throughout the disclosure. The neighbor same cell 22 uses a PCID#2 as a single TP from the perspective of the UE 20 due to the co-location of the MIMO transmit antennas.

In certain embodiments, the neighbor shared cell 23 has two TPs designated TP-A and TP-B, which can be two eNBs. Being within the shared cell 23, TP-A and TP-B both use PCID#3 to scramble their respective CRSs. In the radio environment 200, TP-A and TP-B are not co-located, however, since shared cells can include both co-located and non-co-located TPs. If TP-A uses virtual cell ID-A and TP-B uses virtual cell ID-B, then TP-A and TP-B can transmit their respective CSI-RS scrambled with the respective virtual cell IDs, and the PDSCHs associated with TP-A and TP-B may be sent with virtual cell ID-A and virtual cell ID-B. Since TP-A is in closer proximity to the UE 20 in the radio environment 200, PDSCH transmissions from TP-A may be more likely to interfere than those sent by TP-B. The UE 20 can use this TP proximity information to more effectively mitigate or avoid interference from the neighbor same cell 22 and the neighbor shared cell 23.

In some implementations, the UE 20 may not be able to determine whether a potentially interfering PDSCH in a neighbor cell is sent from the neighbor same cell 22 or the neighbor shared cell 23. According to certain embodiments, the PDSCH can be transmitted from the same antennas that transmit CRS. For LTE Release 11, Transmission Mode 10 (TM10) is introduced, which specifies a quasi co-located (QCL) transmission method. In some implementations, two antenna ports can be considered to be quasi co-located if large-scale properties of the channel over which a symbol on one antenna port is conveyed can be inferred from the channel over which a symbol on the other antenna port is conveyed. The large-scale properties can include one or more of delay spread, Doppler spread, Doppler shift, average gain, and average delay.

In a shared cell ID implementation, the geographically co-located antennas can be grouped to form a TP, which can transmit a CSI-RS and also a PDSCH. The PDSCH signal scrambling identity indicated by the virtual cell ID and other parameters may be different than the scrambling identity for a transmission that originates from a serving cell rather than from a transmission point. In addition, higher layer and physical layer signaling can be used to inform the UE 20 that a PDSCH transmission originates from a particular TP associated with a CSI-RS/CRS. The UE 20 may use the higher layer and physical layer signaling information to estimate timing and frequency error from the co-located CSI-RS/CRS in order to detect the PDSCH.

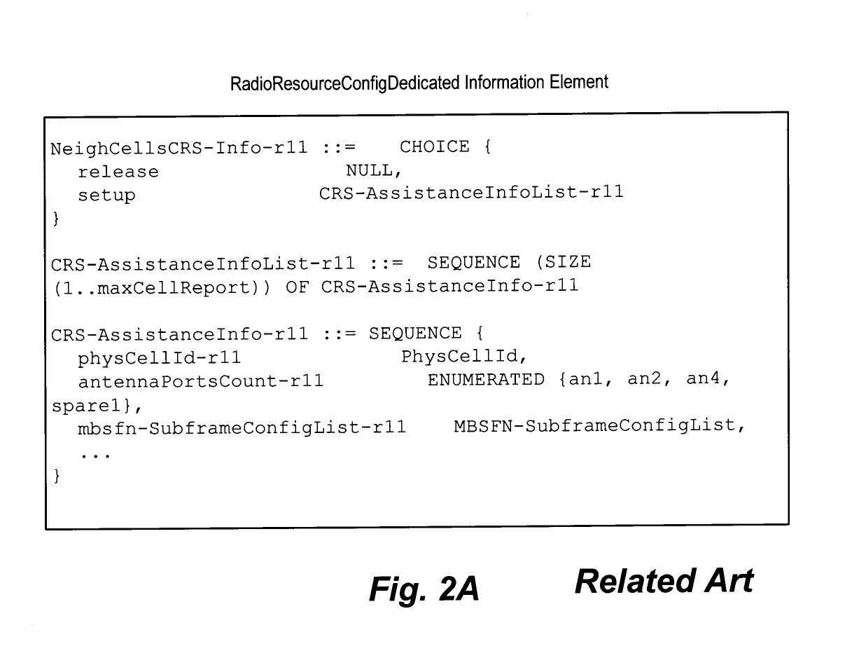

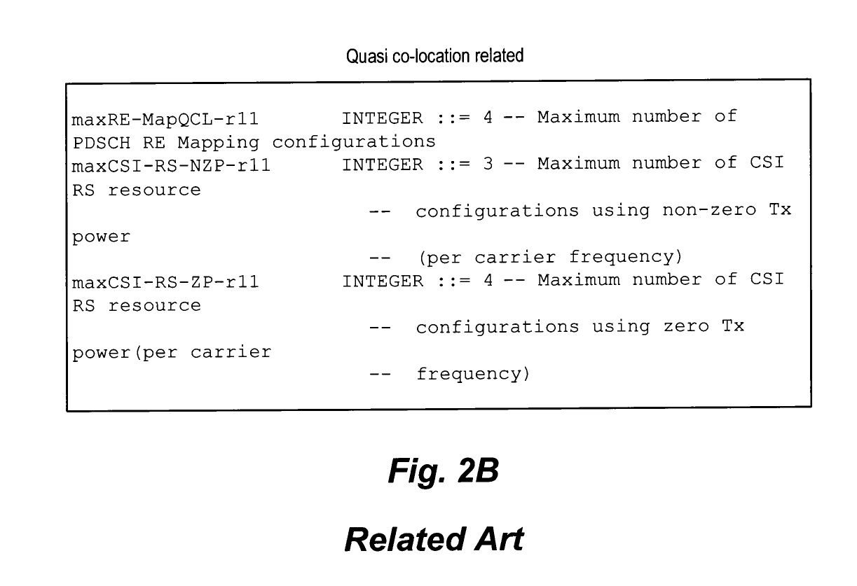

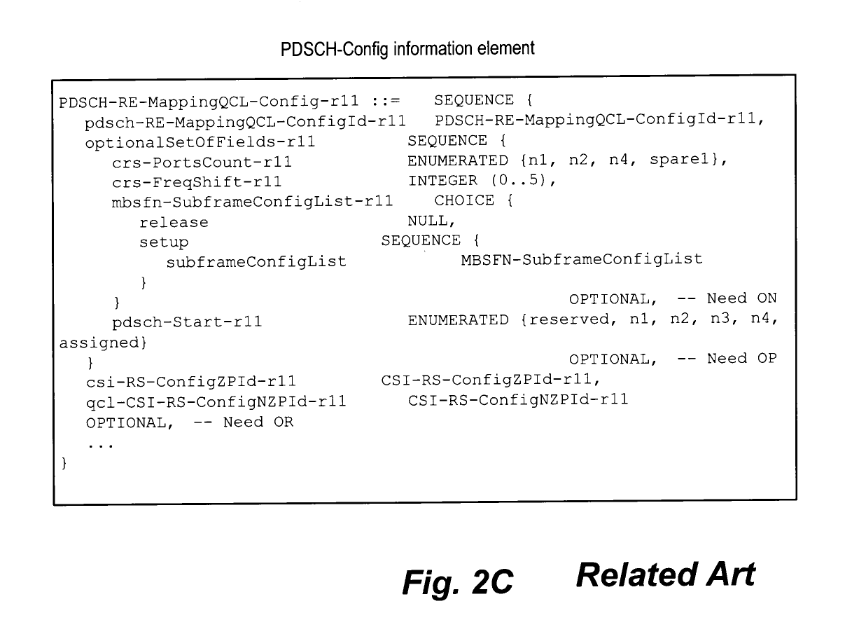

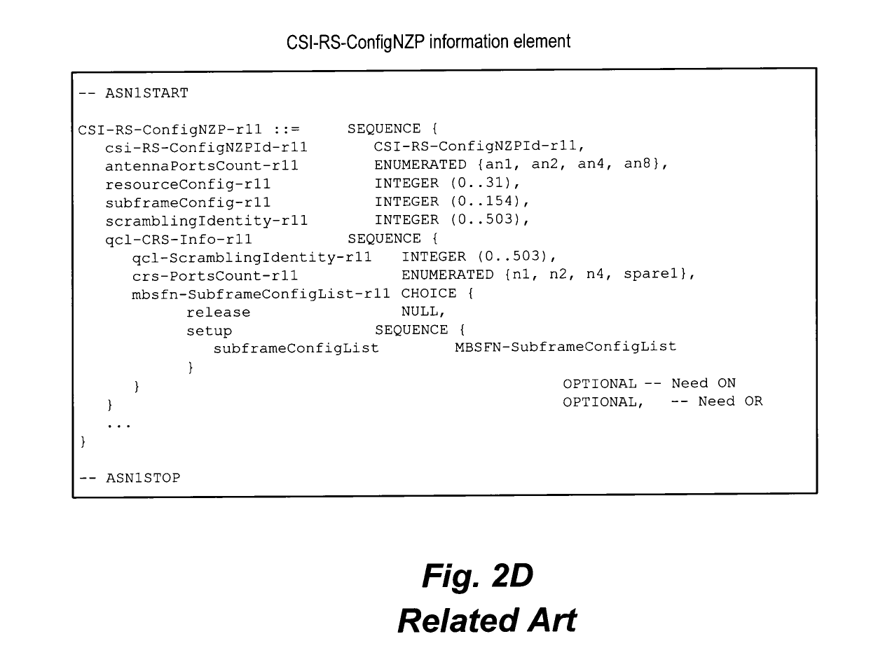

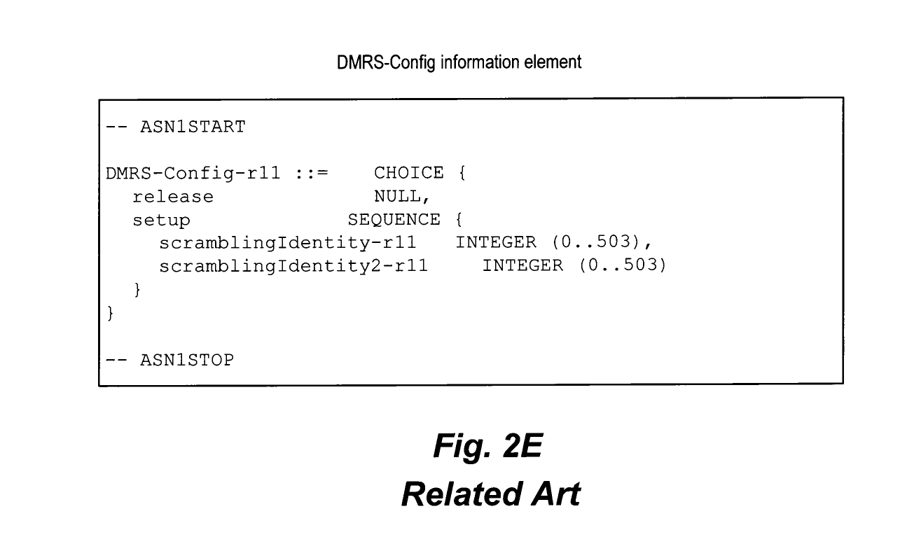

A problem can arise when the signaling of PDSCH configuration information is not associated directly with a physical cell since the TP-specific QCL PDSCH transmission can also be associated with the physical cell. Mitigation of interference by the CRS from neighboring cells can be performed by transmitting signaling fields that include one or more information elements (IEs) in order to distinguish the CRSs for the physical cells and the TPs. For example, FIGS. 2A-2E are exemplary related art IEs described in 3GPP TS 36.331, “Radio Resource Control (RRC) Protocol specification”, V12.1.0 (2014-03), according to certain embodiments.

FIG. 2A illustrates exemplary information carried in a RRC-dedicated IE, according to certain embodiments. The UE 20 can receive a list of CRS assistance information, referred to as CRS-AssistanceInfo-r11, associated with a dedicated radio resource configuration, which can include a list of information that is specific to particular physical cells. For example, the CRS-AssistanceInfo-r11 can include parameters associated with the CRS signal configuration, such as the physical cell identity and the antennas ports count, and the multicast-broadcast single-frequency network (MBSFN) configuration for a particular physical cell.

FIG. 2B illustrates information carried in a QCL IE, according to certain embodiments. For example, the QCL information can include a maximum number of

PDSCH resource element (RE) mapping configurations, a maximum number of CSI-RS resource configurations using non-zero transmit power (per carrier frequency), a maximum number of CSI-RS resource configurations using zero transmit power (per carrier frequency), as well as other types of QCL information.

FIG. 2C illustrates information carried in a PDSCH configuration IE, according to certain embodiments. For example, the PDSCH configuration information can include at least one of QCL mapping information, a count of CRS ports, frequency shift information, MBSFN configuration parameters, PDSCH start information, CSI-RS zero power (ZP) and non-zero power (NZP) configuration information, and the like.

FIG. 2D illustrates information carried in a CSI-RS non-zero power (NZP) configuration IE, according to certain embodiments. The CSI-RS NZP configuration information can include at least one of a CSI-RS configuration identity, an antenna ports count, a resource configuration, a subframe configuration, a scrambling identity, QCL CRS information, and the like.

FIG. 2E illustrates information carried in a demodulation reference signal (DM-RS) configuration IE, according to certain embodiments. The DM-RS configuration information can include one or more SCIDs for the DM-RS.

According to certain embodiments, one problem encountered by NAICS is that the physical layer signaling for the interfering cell PDSCH transmission is absent, and hence the QCL information is missing. One alternative solution is proposed in document R1-142162, entitled “Discussion on higher-layer signaling for NAICS” by LG Electronics; 3GPP TSG RAN WG1 Meeting #77; Seoul, Korea; 19-23 May 2014, where CRS, NZP CSI-RS, ZP CSI-RS and DM-RS information is transmitted to the UE 20. The NZP CSI-RS and DM-RS information includes the QCL information for the interfering cell. However, the document does not specify how the signaling is performed but suggests that for a certain cell all possible QCL and non-QCL PDSCH parameter combinations are signaled. For example, there may be a cell specific entity that includes information on the possible PDSCH transmission combinations.

In addition, a PCID list-based solution may include a list of structures identified by the cell ID that is transmitted to the UE 20. Each structure can include the list of PDSCH information that can possibly be transmitted from the cell. Also, TPs associated with a shared cell can transmit the PDSCH using unique virtual cell IDs. Aspects of this disclosure are directed to defining a QCL PDSCH such that the QCL antennas send PDSCH transmissions to the UE 20, which are virtualizations of a cell, in the case of a same cell ID, and of a transmission point, the case of a shared cell ID. Additional information on QCL procedures is described in 3GPP TS 36.213, “Physical layer procedures”, V12.0.0 (2013-12), the contents of which is incorporated by reference in its entirety.

According to exemplary embodiments of the teachings described herein, the higher layer signaling from the serving cell 21 to the UE 20 is PDSCH-oriented rather than physical cell- or TP-oriented. For example, from the perspective of a UE receiver, the PDSCH signal structure and applicable reference signals at the receiver may have a higher importance than the origin of the potentially interfering PDSCH signals. On the other hand, the processing circuitry of the UE 20 may use information regarding which CRS ports, CSI-RS and scrambling identity the potentially interfering neighbor cell PDSCH is associated with in order to perform timing and frequency error tracking with a predetermined accuracy rate.

In addition, when signaling the UE 20, the circuitry of the serving cell 21 can provide a list of one or more PDSCH configurations to the UE 20. The list may include at least one of two types of entries including type 1 NAICS assistance information entries having PDSCH information associated with a physical cell, which is an extension from the CRS assistance information discussed previously. The list of PDSCH configurations may also include type 2 NAICS assistance information entries having PDSCH information associated with a TP (virtual cell ID) that includes information on QCL parameters.

In certain embodiments, NAICS assistance information is constructed by using the type 2 information, which can be based on performing mapping using QCL assumptions. For example, if a PDSCH transmission originates from a cell rather than from a TP, the PDSCH transmission may be signaled as a QCL signal. The NAICS assistance information can also be applied to a same cell ID.

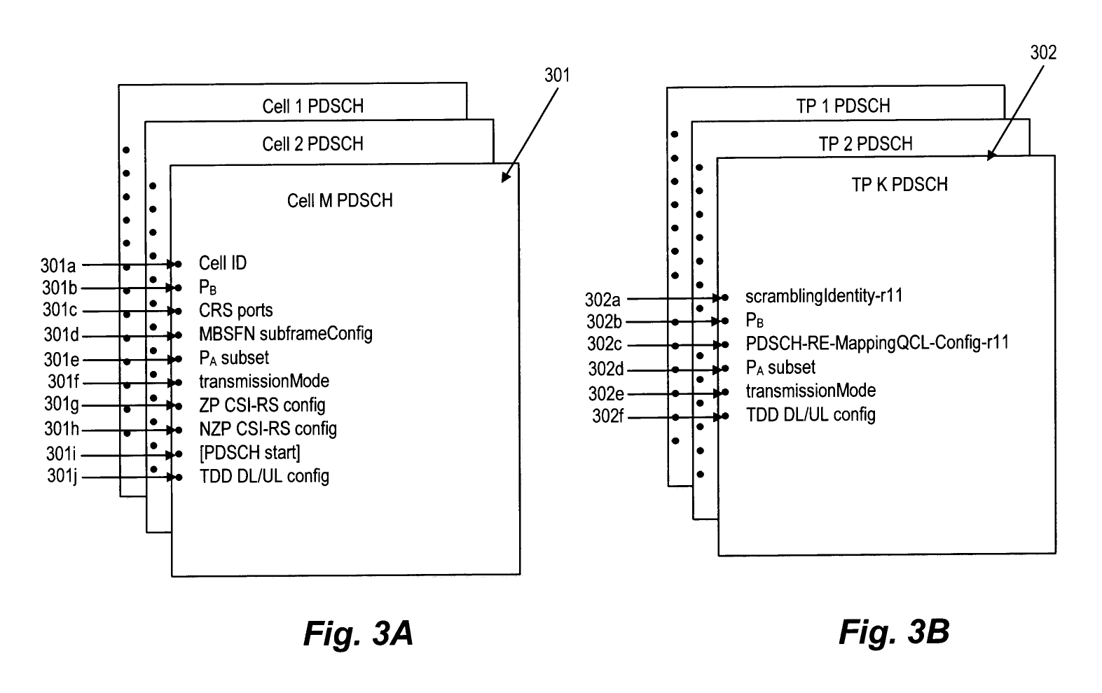

FIG. 3A is an exemplary illustration of a format for providing the type 1 NAICS assistance information associated with a physical cell for same cell neighbors, according to certain embodiments. In this embodiment, the NAICS assistance information can be included in cell-specific list 301. In addition, the cell specific list 301 for the neighbor same cell 22 can also correspond to a TP-specific list since there one TP is located within the neighbor same cell 22. The cell-specific list includes parameters for the same cell ID shared downlink data channel (same-cell PDSCH) such as the Cell ID 301a, a power offset P_{B} 301b for data symbols in orthogonal frequency-division multiplexing (OFDM) symbols having an associated common reference signal, information about which CRS ports 301c the same cell is using, configuration parameters for the cell's MBSFN subframes 301d, a restricted subset of power offsets, P_{A}, between data and reference signal resource elements in OFDM symbols not having an associated common reference signal 301e, the cell's transmission mode 301f, the configurations for ZP CSI-RS 301g, NZP CSI-RS 301h, the start of the PDSCH 301i, and the time division duplex downlink/uplink (TDD DL/UL) subframe configuration 301j.

FIG. 3B is an exemplary illustration of a format for providing the type 2 NAICS assistance information associated with a TP (virtual cell ID) for shared cell neighbors, according to certain embodiments. In this embodiment, the information is in TP specific lists 302. The TP list includes as the parameters for the shared-cell shared downlink data channel (shared-cell PDSCH) including the Release 11 scrambling identity 302a, P_{B} 302b, configuration information about remapping the PDSCH to QCL 302c, a restricted subset of power offsets, P_{A}, between data and reference signal resource elements in OFDM symbols not having an associated common reference signal 302e, the cell's transmission mode 302f, and the time division duplex downlink/uplink subframe configuration 302j.

In a first implementation, the two types of information entries for signaling the UE 20 described with respect to FIGS. 3A and 3B can include NAICS assistance information to mitigate inter-cell interference from neighbor cell PDSCHs. The PDSCH parameters associated with physical cells illustrated in FIG. 3A can be appended to the CRS assistance information (CRS-AssistanceInfo-r11) in the RRC configuration IE as described in 3GPP TS 36.331, “Radio Resource Control (RRC) Protocol specification”, V12.1.0 (2014-03). The PDSCH parameters can include one or more of the parameters summarized in “Draft Report of 3GPP TSG RAN WG1 #77 v0.1.0”, 3GPP TSG RAN WG1 Meeting #77 Seoul, Korea, 19-23 May 2014, the contents of which is incorporated by reference in its entirety.

For example, a cell-specific P_{B} parameter, as described in section 5.2 of 3GPP, “Physical layer procedures”, TS 36.213 V12.0.0 (2013-12), can be appended to the CRS assistance information. In addition, a restricted subset of P_{A} can be appended to the CRS assistance information where the P_{A} is equal to data RE to reference signal (RS) power offset as described in 3GPP, “Physical layer procedures”, TS 36.213 V12.0.0 (2013-12). The transmission mode (TM) can also be appended to the CRS assistance information along with ZP CSI-RS configuration information (csi-RS-ConfigZPId-r11) and NAP CSI-RS configuration information (csi-RS-ConfigNZPId-r11), as described in 3GPP TS 36.331, “Radio Resource Control (RRC) Protocol specification”, V12.1.0 (2014-03), the entire contents of which is incorporated herein by reference.

According to certain embodiments, a new IE can be constructed that includes the PDSCH parameters associated with a virtual cell or TP. For example, the virtual cell IE can include a virtual cell ID and scrambling identity selector (nSCID) pair so that a virtualized PDSCH transmission can be identified by the UE 20. The virtual cell ID can be equal to scramblingIdentity-r11 and/or scramblingIdentity2-r11 as described in 3GPP TS 36.331, “Radio Resource Control (RRC) Protocol specification”, V12.1.0 (2014-03), and the nSCID can be used to select which identity to use. In addition, a flag can be included that indicates whether the PDSCH is being transmitted from a virtual cell and/or via a QCL cell. The virtual cell IE can also include at least one of a CRS port count (crs-PortsCount-r11), a CRS frequency shift value (CRS-FreqShift-r11), MBSFN subframe configuration information (mbsfn-SubframeConfigList-r11), PDSCH start information that describes the starting orthogonal frequency-division multiplexing (OFDM) symbol of the PDSCH (pdsch-Start-r11), ZP CSI-RS configuration information (csi-RS-ConfigZPId-r11), and NZP CSI-RS configuration information (csi-RS-ConfigNZPId-r11), as described in 3GPP TS 36.331, “Radio Resource Control (RRC) Protocol specification”, V12.1.0 (2014-03). These parameters associated with the virtual cell IE can define virtual resource mapping for PDSCH transmissions, and the NZP CSI-RS configuration information, which includes qcl-CRS-Info-r11, defines the quasi co-located CRS for timing and frequency offset estimation for a specific DM-RS. In addition, other parameters described in “Draft Report of 3GPP TSG RAN WG1 #77 v0.1.0”, 3GPP TSG RAN WG1 Meeting #77 Seoul, Korea, 19-23 May 2014, can also be included in the virtual cell IE.

The type 2 information format described with respect to FIG. 3B includes the PDSCH-RE-MappingQCL-Config-r11 302c, which defines a virtual resource element grid defining the amount of information that may be required to determine where the PDSCH is located, independent of whether the signal is transmitted from a cell or from a TP. However, additional information may be needed by the UE 20 with respect the scrambling identities of the CRS, CSI-RS, and DM-RS. The scrambling identities of the CRS, CSI-RS, and DM-RS signals can provide information to the UE 20 that is equivalent to the physical and/or virtual cell ID.

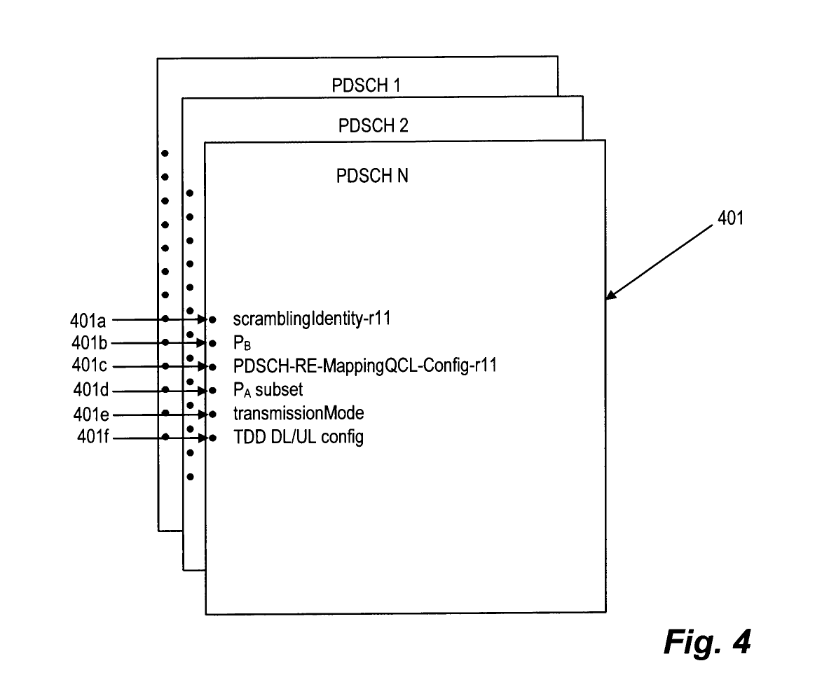

FIG. 4 is an exemplary illustration of a format for signaling PDSCH information using virtual QCL parameters, according to certain embodiments. The PDSCH-specific list 401 illustrated by FIG. 4 shows the virtual QCL parameters that are sent to the UE 20 and is a less complex format when compared to the cell-specific list 301 and TP-specific list 302 described previously with respect to FIGS. 3A and 3B. Also, the content in the PDSCH-specific list 401 more closely resembles the TP-specific list 302 for the type 2 NAIC information. For example, the PDSCH-specific list 401 includes parameters for the shared-cell shared downlink data channel (shared-cell PDSCH) such as the Release 11 scrambling identity 401a, P_{B} 401b, configuration information regarding remapping the PDSCH to QCL (PDSCH-RE-MappingQCL-Config-r11) 401c, a restricted subset of data resource elements of the respective shared-cell downlink data channel associated with respective reference signal power offsets (P_{A}) 401e, the cell's transmission mode 401f, and the time division duplex downlink/uplink subframe configuration 401j.

In another implementation, the NAICS assistance information can be constructed by using the type 2 information alone which represents the virtual PDSCH associated with virtual QCL parameters. The QCL PDSCH can be detected by using the information associated with the PDSCH-RE-MappingQCL-Config and DMRS-Config parameters, which means that the PDSCH transmissions originating from a cell rather than from a TP can also be signaled as QCL transmissions. For example, a virtualized cell ID can be assumed whether the PDSCH originates at a cell or at a TP. In addition, the CSI-RS, CRS, and scrambling parameters can represent the actual physical-layer cell ID and CSI-RS/CRS parameters of a cell in the physical cell ID case as well as the TP and virtual cell parameters as in the shared cell ID case.

If a cell does not have NZP CSI-RS, the QCL CRS information can be added to PDSCH information directly. If the NZP CSI-RS is absent, the UE may assume that the PDSCH is co-located with the CRS.

According to certain embodiments, the virtual PDSCH configuration can include a detailed map of PDSCH resource elements (REs). The REs reserved the CRS and ZP/NZP CSI-RS can be identified at the beginning of the PDSCH allocation. The PDSCH configuration can also include the CRS configuration with respect to antenna ports and frequency shift in the RE grid. ZP/NZP CSI-RS configurations can also be included in the

PDSCH configuration. In addition, scrambling information for CRS, CSI-RS, DM-RS and PDSCH can be derived from the physical-layer cell ID, the virtual cell ID, or the scrambling identity parameters as specified in the LTE specification. Quasi co-location information between virtual PDSCH, CRS and CSI-RS can also be included in the virtual PDSCH configuration. Other PDSCH detection-related parameters can also be included such as power offsets between data and reference signal and transmission mode for multi-antenna processing.

Other PDSCH configuration parameters may include LTE parameters described in 3GPP TS 36.331, “Radio Resource Control (RRC) Protocol specification”, V12.1.0 (2014-03) and may include virtual resource mapping parameters such as scramblingIdentity-r11 or scramblingIdentity2-r11, crs-PortsCount-r11, crs-FreqShift-r11, mbsfn-SubframeConfigList-r11, pdsch-Start-r11, csi-RS-ConfigZPId-r11, qcl-CSI-RS-ConfigNZPId-r11 which also includes QCL CRS information, and qcl-CRS-Info-r11 if NZP CSI-RS configuration does not exist. Other NAICS parameters can include P_{B}, Restricted subset of P_{A}, and transmission mode.

The serving cells that make up the radio environment 200 may update the NAICS assistance information of the UE 20 based on measurement reports that can include reference signal received power (RSRP). For example, when the UE 20 receives the list of PDSCH information, the UE 20 can use the QCL CRS and CSI-RS information to select a subset which is then used in further NAICS processing and detection of the actually transmitted

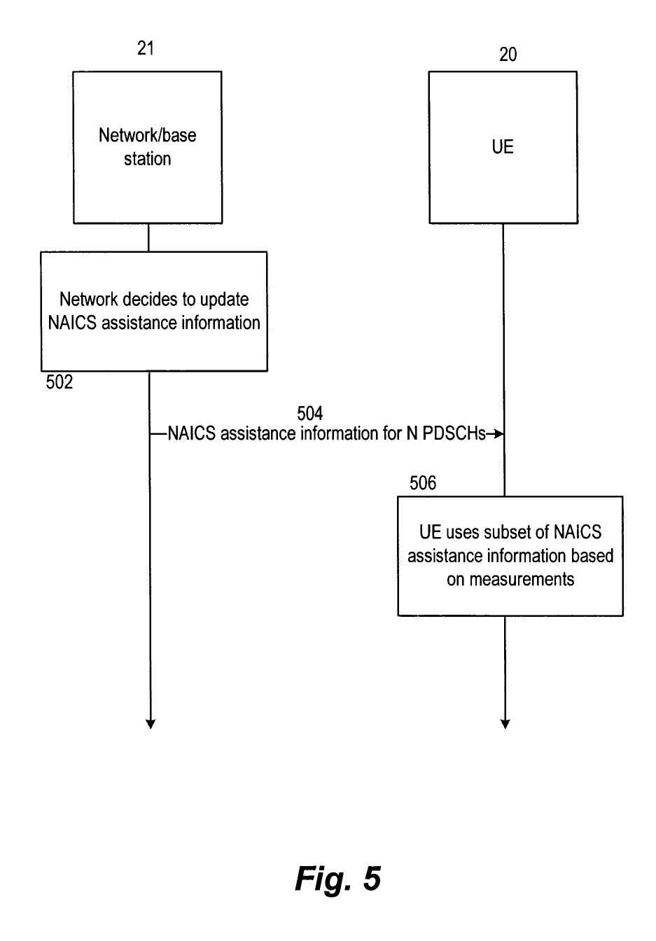

PDSCH. FIG. 5 is an exemplary schematic diagram illustrating a network's signaling of NAICS assistance information to a UE, according to certain embodiments. The serving cell/base station 21 can update the NAICS assistance information at block 502 based on an RSRP received from the UE 20 and can signal the NAICS assistance information update at 504 for a group of N PDSCHs.

At block 506, the UE 20 uses a subset of the group of N PDSCHs to update the NAICS assistance information, where the subset is selected based on the UE's measurements that were reported to the serving cells at block 502. For example, the subset selection may be based on power calculations from the co-located reference signals. The UE 20 may select the PDSCHs having a received power that is greater than a predetermined threshold to be processed further. In some embodiments, the UE 20 selects a predetermined number of PDSCHs having a highest received power for further processing.

Embodiments of these teachings provide the technical effect of signaling which allows both reception of conventional PDSCH transmissions from physical cells and PDSCH transmissions from virtualized cell without uncertainty on quasi co-located CSI-RS/CRS for timing and frequency error tracking. In addition, the complexity of managing the signaling of a total amount of PDSCH information is reduced due to the configuration of the PDSCH parameters described herein. The signaling space, such as the radio environment 200, can include both cell and TP-based transmission parameters as appropriate.

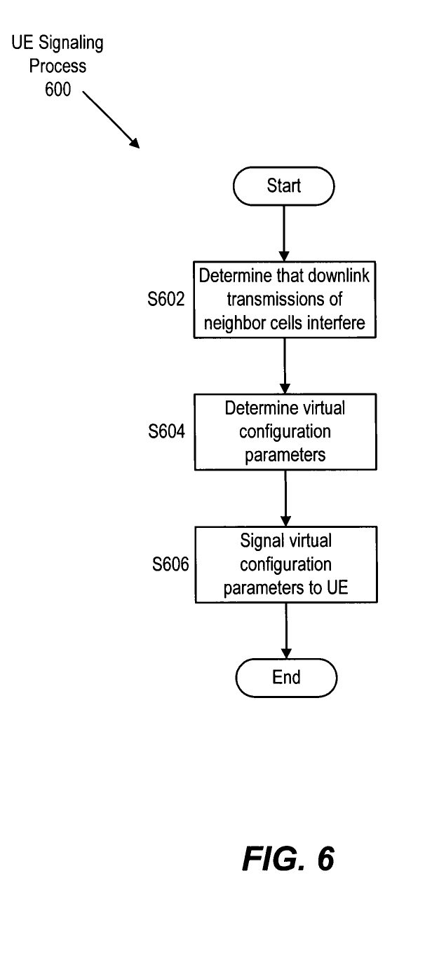

FIG. 6 is an exemplary flowchart of a UE signaling process, according to certain embodiments. At step S602, the processing circuitry of the serving cell 21 determines that one or more downlink transmissions from one or more neighbor cells, such as the neighbor same cell 22 and the neighbor shared cell 23, may interfere with PDSCH transmissions to the UE 20. The determination that there may be interference from the downlink transmissions from the one or more neighbor cells can be based on proximity of the neighbor cells to the UE 20, transmit power of the downlink transmissions from the neighbor cells, RSRP at the UE 20, and the like.

At step S604, the processing circuitry of the serving cell 21 determines one or more virtual configuration parameters representing the NAICS information for the PDSCH transmissions from the interfering neighbor cells so that the UE 20 can perform timing and frequency error tracking with a predetermined accuracy rate based on the virtual configuration parameters. For example, in one implementation, the NAICS assistance information can be constructed by using the type 2 information alone which represents the virtual PDSCH associated with virtual QCL parameters. The QCL PDSCH can be detected by using the information associated with the PDSCH-RE-MappingQCL-Config and DMRS-Config parameters, which means that the PDSCH transmissions originating from a cell rather than from a TP can also be signaled as QCL transmissions. For example, a virtualized cell ID can be assumed whether the PDSCH originates at a cell or at a TP. In addition, the CSI-RS, CRS, and scrambling parameters can represent the actual physical-layer cell ID and CSI-RS/CRS parameters of a cell in the physical cell ID case as well as the TP and virtual cell parameters as in the shared cell ID case

At step S606, the processing circuitry of the serving cell 21 signals the virtual configuration parameters to the UE 20. For example, the virtual configuration parameters can describe QCL PDSCHs which are PDSCH transmissions that are sent via QCL antenna ports, which can represent a virtualization of a cell (in the same cell ID scenario) and of a transmission point (in the shared cell ID scenario). The interfering PDSCHs are virtualized by the serving cell 21 network for the UE 20 as QCL PDSCHs, and the UE 20 receives the parameter configuration lists discussed previously that are related to the virtualized QCL PDSCHs.

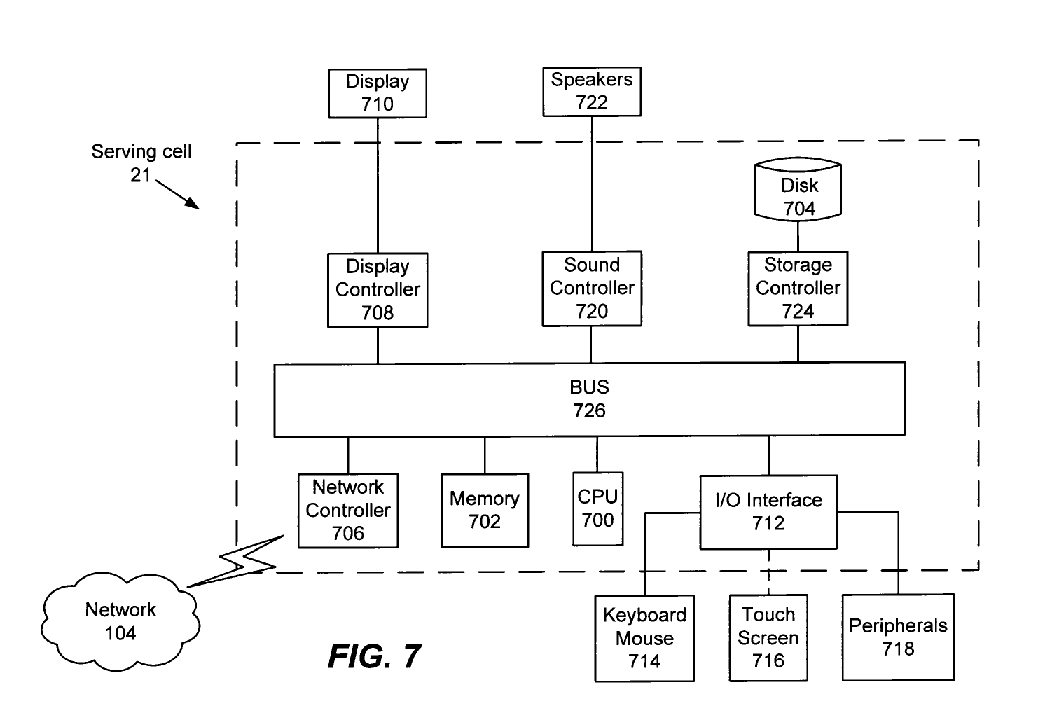

A hardware description of a serving cell 21 according to exemplary embodiments is described with reference to FIG. 7. The hardware described by FIG. 7 can apply to the circuitry associated with the serving cell 21 signaling the UE 20 with the PDSCH configuration information, such as the virtual configuration parameters associated with the QCL PDSCH. In addition, the hardware described by FIG. 7 can also apply to the circuitry of the UE 20, neighbor same cell 22, neighbor shared cell 23, other higher level network entities associated with the MAC (L2) and network layer (L3), and any other hardware component associated with the radio environment 200. The processes described herein can also be performed by processing circuitry of a processor designed and programmed specifically to optimally perform the UE signaling process 600 described previously herein. Implementation of the UE signaling process 600 on the hardware described herein improves the ability of the UE 20 to mitigate the effects of interfering PDSCHs based on the configurations of the QCL PDSCHs signaled to the UE 20 by the serving cell 21.

The processor includes a CPU 700 that perform the processes described above/below. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the processor of the serving cell 21 communicates, such as the UE 20, neighbor same cell 22, neighbor shared cell 23, and the like.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

The hardware elements in order to achieve the processor of the serving cell 21 may be realized by various circuitry elements, known to those skilled in the art. For example, CPU 700 may be a Xenon or Core processor from Intel of America or an Opteron processor from AMD of America, or may be other processor types that would be recognized by one of ordinary skill in the art. Alternatively, the CPU 700 may be implemented on an FPGA,

ASIC, PLD or using discrete logic circuits, as one of ordinary skill in the art would recognize. Further, CPU 700 may be implemented as multiple processors cooperatively working in parallel to perform the instructions of the inventive processes described above.

The serving cell 21 in FIG. 7 also includes a network controller 706, such as an Intel Ethernet PRO network interface card from Intel Corporation of America, for interfacing with network 104. As can be appreciated, the network 104 can be any E-UTRAN/LTE network but can also be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems.

The wireless network can also be Wi-Fi, Bluetooth, or any other wireless form of communication that is known. For example, the network 104 can include the radio environment 200 discussed previously herein.

In addition, while not particularly illustrated for the serving cell 21, UE 20, neighbor same cell 22, and neighbor shared cell 23, these devices can include a modem and/or a chipset and/or an antenna chip which may or may not be inbuilt onto a radiofrequency (RF) front end module within the respective host device. These devices can also include transmitter and receiver hardware for wireless communications between the serving cell 21, UE 20, neighbor same cell 22, and neighbor shared cell 23. The serving cell 21 further includes a display controller 708, such as a NVIDIA

GeForce GTX or Quadro graphics adaptor from NVIDIA Corporation of America for interfacing with display 710 of the UE, such as a Hewlett Packard HPL2445w LCD monitor. A general purpose I/O interface 712 at the UE 106 interfaces with a keyboard and/or mouse 714 as well as a touch screen panel 716 on or separate from display 710. General purpose I/O interface 712 also connects to a variety of peripherals 718 including printers and scanners, such as an OfficeJet or DeskJet from Hewlett Packard.

A sound controller 720 is also provided in the serving cell 21, such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the serving cell 21. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

In other alternate embodiments, processing features according to the present disclosure may be implemented and commercialized as hardware, a software solution, or a combination thereof. Moreover, instructions corresponding to the UE signaling process 600 in accordance with the present disclosure could be stored in a thumb drive that hosts a secure process.

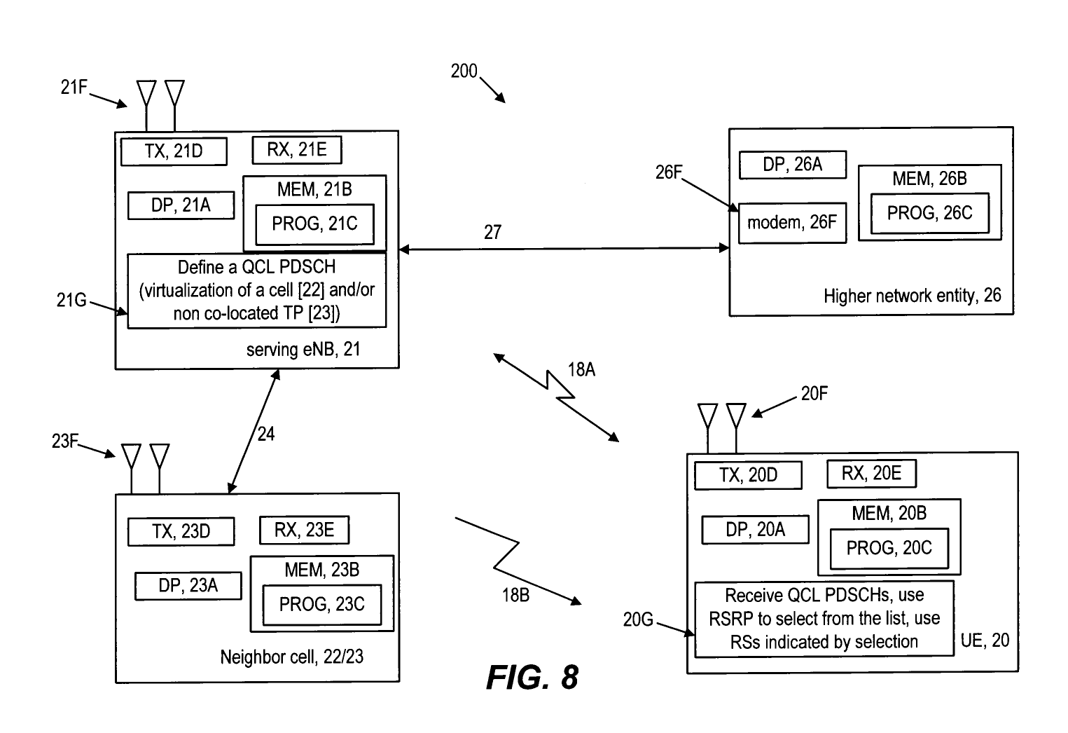

FIG. 8 is a high level schematic block diagram of the radio environment 200, according to certain embodiments. The components of the radio environment 200, such as the serving cell 21, neighbor same cell 22, neighbor shared cell 23, and UE 20, include one or more hardware devices for practicing the exemplary embodiments of the teachings described herein. For example, the UE 20 includes a processor, such as at least one data processor (DP) 20A, which can also be referred to as processing circuitry, memory such as at least one computer-readable memory 20B storing instructions for executing at least one software program 20C, and also communication circuitry that can include a transmitter TX 20D and a receiver RX 20E for bidirectional wireless communications with the serving cell 21 using the operative radio access technology. Wireless communications can be performed via one or more antennas 20F.

One of the PROGs 20G in the MEM 20B of the UE 20 can issue software instructions to the circuitry of the DP 20A to use the QCL PDSCH the received from the serving cell 21 eNB and the measured RSRP provided to the serving cell 21 to select one or more of the virtual configuration parameters/QCL PDSCHs received by the UE 20. For example, the processing circuitry of the UE 20 can perform channel estimation from reference signals indicated by the virtual configuration parameters and also perform joint detection of serving cell downlink data channel data and an interfering data channel data indicated by the selected virtual configuration (such as for example maximum likelihood (ML) detection).

According to certain embodiments, the QCL PDSCH refers to PDSCH transmissions that are sent via QCL antenna ports, which can represent a virtualization of a cell (in the same cell ID scenario) and of a transmission point (in the shared cell ID scenario). The interfering PDSCHs are virtualized by the serving cell 21 network for the UE 20 as QCL PDSCHs, and the UE 20 receives the parameter configuration lists discussed previously that are related to the virtualized QCL PDSCHs.

The serving cell 21 and the neighbor cell 22/23 are also shown in FIG. 8. Each of these cells 21-23 also have at least one DP/processing circuitry 21A/22A/23A, a MEM 21B/22B/23B storing a PROG 21C/22C/23C, and communication circuitry such as transmitters 21E/22E/23E and receivers 21D/22D/23D that interface to one or more antennas 21F/22F/23F. One of the relevant PROGs 21G in the MEM 21B of the serving cell 21 includes software instructions to define/create the QCL PDSCHs, which are each a virtualization of a cell in the same cell ID scenario and of a transmission point in the shared cell ID scenario. The processing circuitry in the DP 21A of the serving cell 21 sends on link 18A to the UE 20 the parameter configuration lists associated with the virtualized QCL PDSCHs, according to certain embodiments. The processing circuitry in the DP 20A of the UE 20 uses the received parameter configuration lists to select reference signals that the neighbor same cell 22 and/or neighbor shared cell 23 will be transmitting on link 18B. Knowing the reference signals in use, the UE 20 can then measure the neighbor cell and estimate interference from it.

FIG. 8 additionally shows a higher network node 26 also having a DP/processing circuitry 26A, a MEM 26B storing PROGs 26C, and a modem for modulating and demodulating signals to/from the serving cell 21 over the control and data link. In some cases the neighbor cells 22/23 may also communicate with the higher network entity 26, and the serving cell 21 may also communicate via an X1 or other interface 24 with one or more of the neighbor cells 22/23.

At least one of the PROGs 20C/20G in the UE 20 can include one or more software instructions that, when executed by the associated DP/processing circuitry 20A, enable the device to operate in accordance with the exemplary embodiments of the disclosure, as described herein. Similar also for the PROGs 21C/21G in the serving cell 21 and the PROGs 26C in the MEM 26B of the higher network entity 26 can also include one or more software instructions that, when executed by the associated DP/processing circuitry 21A/26A, enable the devices to operate in accordance with the exemplary embodiments of the disclosure, as described herein.

The exemplary embodiments of this disclosure may be implemented at least in part by computer software stored on the MEM 20B/21B/26B which is executable by the DP/processing circuitry 20A/21A/26A of the UE 20 and/or serving cell 21 or higher network entity 26; or by hardware, or by a combination of tangibly stored software and hardware (and tangibly stored firmware) in any one or more of the MEMs 20B/21B/26B. In this manner the respective DP/processing circuitry 20A/21A/26A with the MEM 20B/21B/26B and stored PROG 20C/20G/21C/21G/26C may be considered a data processing system. Electronic devices implementing these aspects of the invention may not include the entire UE 20 or eNB 21, 22/23 as depicted at FIG. 8, but instead may be one or more components thereof such as the above described tangibly stored software, hardware, firmware and DP/processing circuitry, and/or a system on a chip SOC and/or an application specific integrated circuit ASIC and/or a digital signal processor DSP (including multiple core processors and other arrangements of circuitry) and/or a modem and/or an antenna module and/or a radiofrequency RF front end module.

In general, the various embodiments of the UE 20 can include, but are not limited to personal portable digital devices having wireless communication capabilities, such as for example cellular and other mobile phones including smartphones, navigation devices, laptop/palmtop/tablet computers, digital cameras and music devices, Internet appliances, USB dongles and data cards. Such portable digital devices may be implemented as radio communications handsets, wearable radio communications terminals, implanted radio communications terminals, and/or combinations of these.

Various embodiments of the computer readable MEMs 20B/21B/23B/26B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A/21A/23A/26A include but are not limited to general purpose computers, special purpose computers, microprocessors, digital signal processors (DSPs) and multi-core processors, though in other embodiments the implementing hardware is more generally characterized as circuitry.

Various modifications and adaptations to the foregoing exemplary embodiments of this invention may become apparent to those skilled in the relevant arts in view of the foregoing description. While the exemplary embodiments have been described above in the context of the E-UTRAN/LTE and LTE-Advanced radio access technology, as noted above the exemplary embodiments of this invention are not limited for use with only these particular types of wireless radio access technology networks.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

1. An apparatus comprising:
circuitry configured to
determine that one or more neighbor transmission cells have interfering downlink data channels to be transmitted by one or more antenna groups,
determine virtual configuration parameters for the interfering downlink data channels, and
signal, to at least one user equipment (UE) served by a serving cell that is one of the one or more neighbor transmission cells having interfering downlink data channels, the virtual configuration parameters for the interfering downlink data channels.

2. The apparatus of claim 1, wherein the one or more neighbor transmission cells includes at least one same cell identity (ID) including a serving cell with one or more transmit antennas that are physically co-located.

3. The apparatus of claim 2, wherein the circuitry is further configured to identify the at least one same cell ID based on a physical cell ID.

4. The apparatus of claim 1, wherein the one or more neighbor transmission cells includes at least one shared cell ID including a serving cell with one or more transmit antennas that are associated with one or more geographically distinct transmission points.

5. The apparatus of claim 4, wherein the circuitry is further configured to identify the one or more transmission points based on a virtual cell ID.

6. The apparatus of claim 1, wherein the circuitry is further configured to determine the virtual configuration parameters to establish a quasi co-located physical downlink shared channels (PDSCHs) corresponding to the interfering downlink data channels.

7. The apparatus of claim 1, wherein the circuitry is further configured to determine the virtual configuration parameters to achieve network assistance interference cancellation and suppression (NAICS).

8. The apparatus of claim 2, wherein the circuitry is further configured to assign the virtual configuration parameters associated with the at least one same cell ID to a first cell list.

9. The apparatus of claim 8, wherein the virtual configuration parameters assigned to the first cell list include at least one of
a physical cell ID;
a subset of power offsets, P_{A}, between data and reference signal resource elements in orthogonal frequency-division multiplexing (OFDM) symbols not having an associated common reference signal;
an additional power offset, P_{B}, relative to P_{A} for data symbols in OFDM symbols having associated common reference symbol (CRS) ports;
a multicast-broadcast single-frequency network (MBSFN) subframe configuration;
at least one transmission mode;
a zero power (ZP) channel state information- reference signal (CSI-RS) configuration;
a non-zero power (NZP) CSI-RS configuration;
PDSCH start information; and
a time division duplex downlink/uplink (TDD DL/UL) configuration.

10. The apparatus of claim 9, wherein the circuitry is further configured to append the virtual configuration parameters assigned to the first cell list to CRS assistance information in a radio resource configuration (RRC) information element.

11. The apparatus of claim 3, wherein the circuitry is further configured to assign the virtual configuration parameters associated with at least one shared cell ID to a second cell list.

12. The apparatus of claim 11, wherein the circuitry is further configured to determine the virtual configuration parameters for the interfering downlink data channels including at least one of:
scrambling identities used for transmitting the interfering downlink data channels by the one or more associated transmission cells including demodulation reference signal information;
quasi co-location information including resource element mapping;
scrambling identity and antenna port information associated with one or more common reference signal transmissions;
scrambling identity and antenna port information associated with one or more channel state information reference signal transmissions;
a subset of power offsets, P_{A}, between data and reference signal resource elements in OFDM symbols not having an associated common reference signal; and
an additional power offset, P_{B}, relative to P_{A} for data symbols in OFDM symbols having an associated common reference symbol.

13. The apparatus of claim 12, wherein the scrambling identities further comprise a virtual cell identity (ID) identifying a set of at least two scrambling identities.

14. The apparatus of claim 13, wherein the circuitry is further configured to select one scrambling identity from the set based on a selector value (nSCID).

15. The apparatus of claim 12, wherein the circuitry is further configured to indicate that the PDSCHs are transmitted from at least one of a physical cell, a virtual cell, and a quasi co-location cell via at least one flag.

16. The apparatus of claim 12, wherein the circuitry is further configured assign the virtual configuration parameters from the second list to at least one same cell ID having a serving cell with one or more transmit antennas that are physically co-located.

17. The apparatus of claim 1, wherein the circuitry is further configured to signal the virtual configuration parameters for the interfering downlink data channels in response to receiving a measurement report from the at least one UE.

18. The apparatus of claim 1, wherein the circuitry is further configured to update NAICS assistance information based on the measurement report received from the at least one UE.

19. A method comprising:
determining that one or more neighbor transmission cells have interfering downlink data channels to be transmitted by one or more antenna groups;
determining virtual configuration parameters for the interfering downlink data channels; and
signaling, to at least one UE served by a serving cell that is one of the one or more neighbor transmission cells having interfering downlink data channels, the virtual configuration parameters for the interfering downlink data channels.

20. A serving cell comprising:
circuitry configured to
identify transmission points associated with one or more interfering antenna groups,
determine virtual configuration parameters for the transmission points based on physical layer and higher layer attributes of the transmission points, and
signal, to at least one user equipment (UE) served by the serving cell, the virtual configuration parameters associated with the transmission points.
